(19) United States
(12) Patent Application Publication
(10) Pub. No.: US 2022/0104616 A1
(43) Pub. Date: Apr. 7, 2022

(54) CABINET WITH HOOK AND BOLT BASED FASTENING DEVICE

(71) Applicants: Kung-Cheng Chen, Taichung City (TW); Lung-Chuan Huang, Taichung City (TW)

(72) Inventors: Kung-Cheng Chen, Taichung City (TW); Lung-Chuan Huang, Taichung City (TW)

(21) Appl. No.: 17/064,081

(22) Filed: Oct. 6, 2020

(51) Int. Cl. A47B 47/00; F16B 21/09; F16B 12/14; F16B 5/06; F16B 5/00

(52) U.S. Cl. CPC A47B 47/0008; F16B 21/09; F16B 12/14; A47B 2210/0002; F16B 5/0036; A47B 47/0016; F16B 2012/145; F16B 5/0614

(57) ABSTRACT

A cabinet includes four upright members having a triangular section and including two outer boards, an inner board, and two longitudinal groove formed at a joining portion of a first end of the inner board and an end of one outer board and at a joining portion of a second end of the inner board and an end of the other outer board respectively, the inner board including an upper first through hole and a lower second through hole; a plurality of board members each including four through holes at four corners respectively; a plurality of fastening devices at the through holes of the board members respectively, each fastening device including a hook assembly and a bolt and nut combination for securing the hook assembly, the upright member, and the board member together; and three board elements each disposed between the grooves of two adjacent upright members.

### BACKGROUND OF THE INVENTION

### 1. Field of the Invention

The invention relates to cabinets and more particularly to a cabinet including upright members and board members releasably fastened together by hook and bolt based fastening devices.

### 2. Description of Related Art

Ready-to-assemble furniture (RTA) is a form of furniture that requires customer assembly. The separate components are packed for sale in cartons which also contain assembly instructions and sometimes hardware. The furniture is generally simple to assemble with basic tools such as screwdrivers. RTA is popular with consumers who wish to save money by assembling the product themselves. For example, screws are used to assemble components (e.g., upright members, board members and board elements) of a cabinet.

However, it is often that the assembled cabinet is not secured or even slanted. A disassembly of the cabinet is also very difficult and time consuming.

U.S. Pat. No. 10,506,876 to Chen et al. discloses a self-assembly cabinet. While the device enjoys its success in the market, continuing improvements in the exploitation of cabinet of this type are constantly being sought.

### SUMMARY OF THE INVENTION

The invention has been made in an effort to solve the problems of the conventional art including the assembled cabinet being not secured or even slanted, and a disassembly of the cabinet being very difficult and time consuming by providing a cabinet having novel and nonobvious characteristics.

To achieve above and other objects of the invention, the invention provides a cabinet comprising a plurality of upright members each having a triangular section and including two outer boards perpendicular to each other, an inner board, and two longitudinal groove formed at a joining portion of a first end of the inner board and an end of one outer board and at a joining portion of a second end of the inner board and an end of the other outer board respectively wherein the inner board includes a first through hole adjacent to an upper end, and a second through hole adjacent to a lower end; a plurality of board members each including four through holes at four corners respectively; a plurality of fastening devices disposed at the through holes of the board members respectively, each fastening device including a hook assembly and a bolt and nut combination for securing the hook assembly, the upright member, and the board member together; and a plurality of board elements each having two ends complimentarily disposed in the grooves of two adjacent ones of the upright members respectively; wherein each board member is disposed on tops or bottoms of the upright members; wherein the first one of the hook assemblies associated with the upper one of the board members passes through the first through hole and is attached thereto, and wherein the second one of the hook assemblies associated with the lower one of the board members passes through the second through hole and is attached thereto.

The above and other objects, features and advantages of the invention will become apparent from the following detailed description taken with the accompanying drawings.

### BRIEF DESCRIPTION OF THE DRAWINGS

FIG. 1 is a perspective view of a cabinet according to a first preferred embodiment of the invention;

FIG. 2 is a perspective, exploded view of the cabinet;

FIG. 3 is a sectional view of one of four corners of the cabinet;

FIG. 4 is another perspective, exploded view of the cabinet;

FIG. 5 is an exploded view of the upright member, the board member and the fastening device;

FIG. 6 is a perspective view of the upright member;

FIG. 7 is a longitudinal sectional view of the upright member, the board member and the fastening device in an assembled state;

FIG. 8A is a perspective view of the hook assembly;

FIG. 8B is a perspective view of another configuration of the hook assembly;

FIG. 9 is a perspective, exploded view of a cabinet according to a second preferred embodiment of the invention;

FIG. 10 is a perspective, exploded view of a cabinet according to a third preferred embodiment of the invention;

FIG. 11 is a perspective, exploded view of a cabinet according to a fourth preferred embodiment of the invention;

FIG. 12 is an exploded view of the upper upright member, the board member, the fastening device and the lower upright member of the cabinet of FIG. 11;

FIG. 13 a perspective view of a cabinet according to a fifth preferred embodiment of the invention with drawers removed; and

FIG. 14 is a perspective view of the cabinet of FIG. 13 with the drawers being mounted.

### DETAILED DESCRIPTION OF THE INVENTION

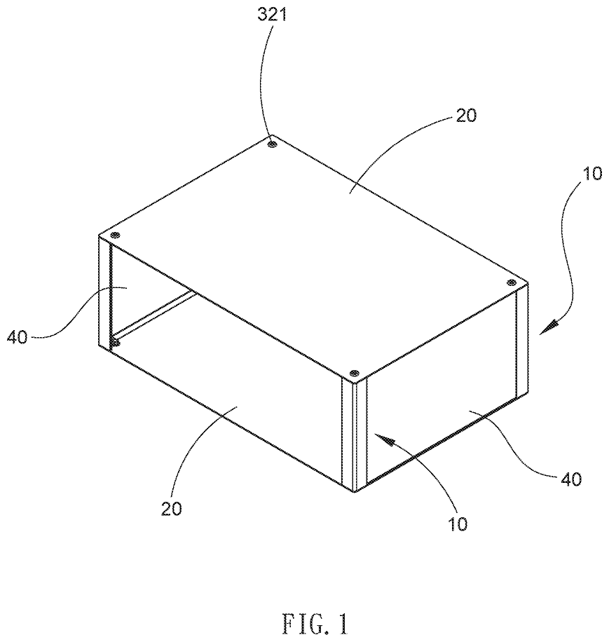

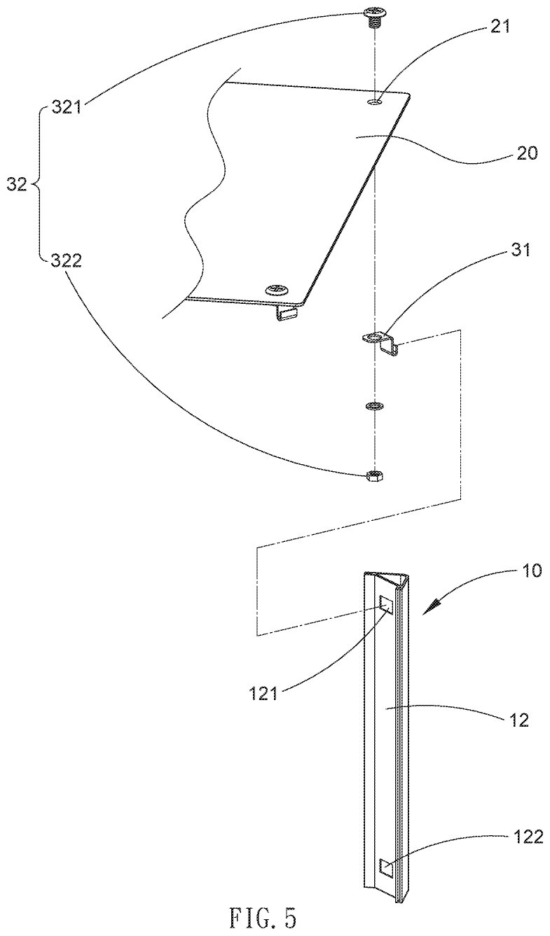

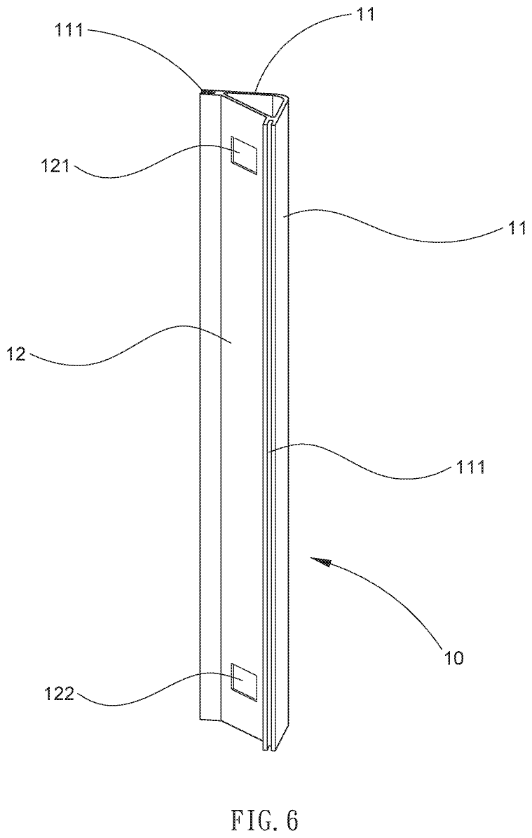

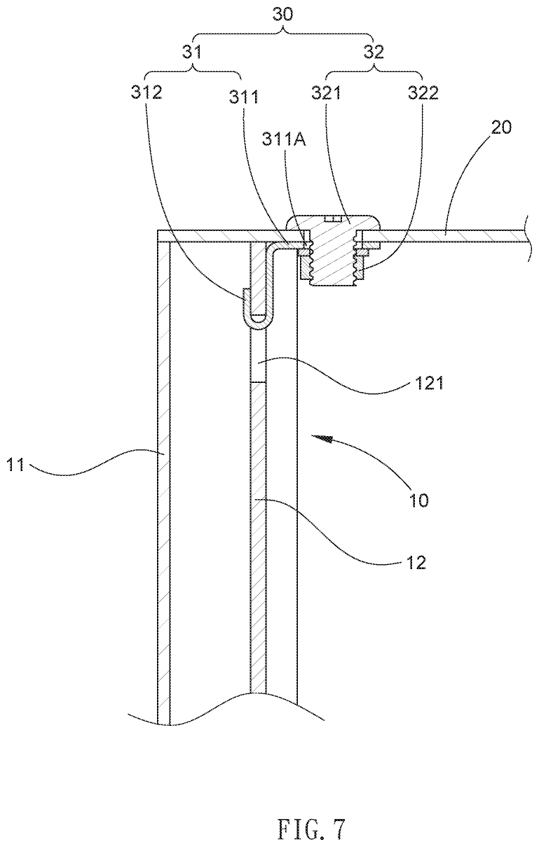

Referring to FIGS. 1 to 8B, a cabinet of a first preferred embodiment of the invention comprises four upright members 10, two board members 20, eight fastening devices 30 and three board elements 40 as discussed in detail below.

The upright member 10 is made of aluminum and is hollow. The upright member 10 has a triangular section and includes two outer boards 11 formed integrally and being perpendicular to each other, and an inner board 12 being at an angle of 45 degrees with respect to either outer board 11. Two longitudinal grooves 111 are formed at a joining portion of a first end of the inner board 12 and an end of one outer board 11 and at a joining portion of a second end of the inner board 12 and an end of the other outer board 11 respectively. The inner board 12 includes a rectangular first through hole 121 adjacent to an upper end, and a rectangular second through hole 122 adjacent to a lower end.

The board member 20 is rectangular and includes four through holes 21 at four corners respectively. The fastening devices 30 are disposed at the through holes 21 of the board members 20 respectively. The fastening device 30 includes a hook assembly 31 including a body 311 having a through hole 311A, and a hook 312 inserted through the first through hole 121 with an upper edge of the first through hole 121 in the hook 312; and a bolt and nut combination 32 including a bolt 321 and a nut 322. The bolt 321 is driven through the through hole 21, the through hole 311A and the nut 322 to secure the upright member 10 and the upper one of the board members 20 together.

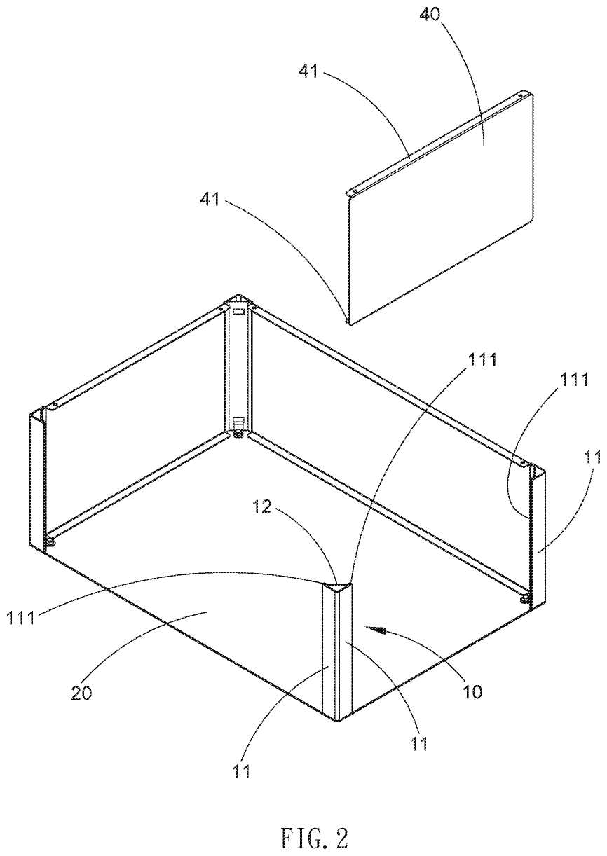

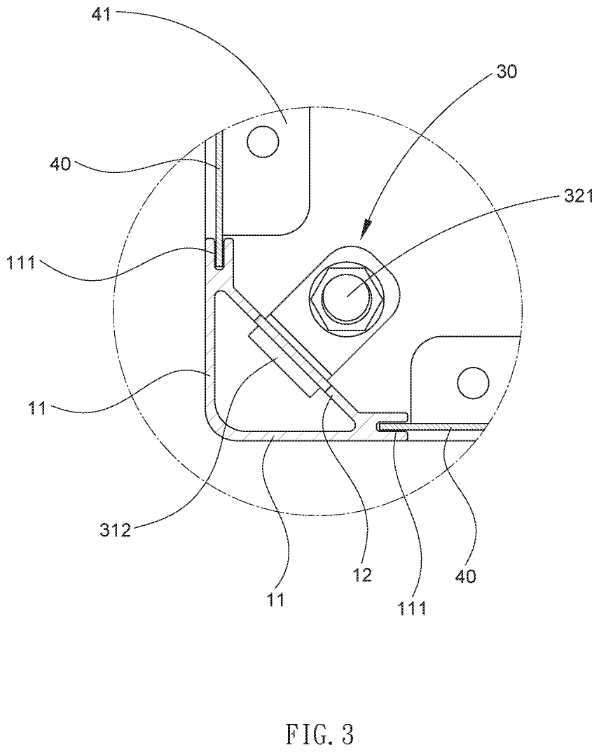

As shown in FIGS. 2 and 3 specifically, the board element 40 has two ends complimentarily disposed in the grooves 111 of two adjacent ones of the upright members 10 respectively. The board element 40 is at an angle of 135 degrees with respect to the inner board 12. The board element 40 includes two inward extensions 41 on top and bottom edges respectively for increasing structural strength thereof.

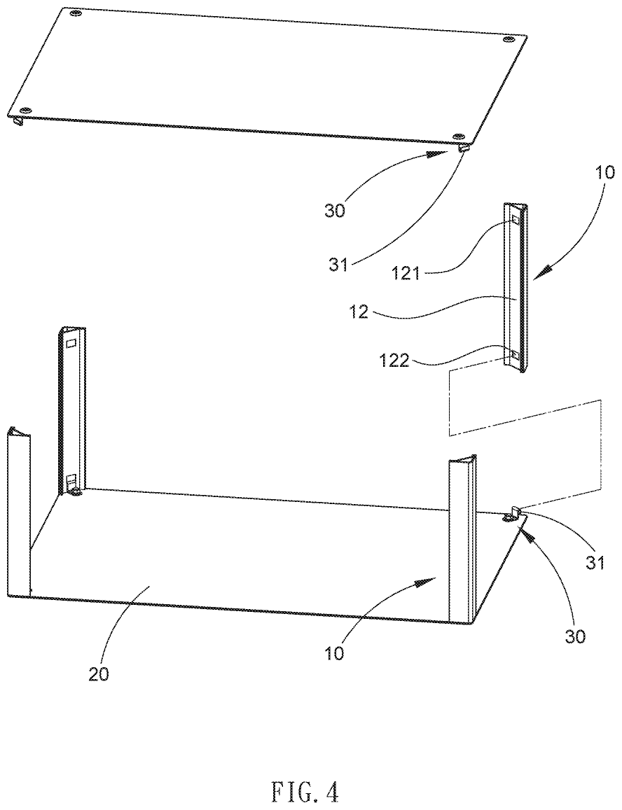

As shown in FIGS. 4, 5 and 7 specifically, it is possible of securing upper ends of the upright member 10 and the upper one of the board members 20 together by performing the step of driving the bolt 321 through the through hole 21, the through hole 311A and the nut 322 four times; and securing lower ends of the upright member 10 and the lower one of the board members 20 together by performing the step of driving the bolt 321 through the through hole 21, the through hole 311A and the nut 322 four times. Also, the board elements 40 are fastened. As a result, the cabinet is assembled. A disassembly of the cabinet is made easy by unfastening the fastening devices 30 and performing other associated steps.

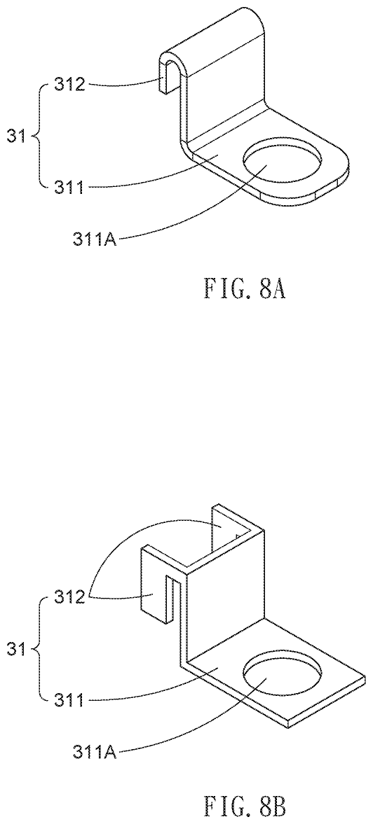

As shown in FIG. 8A specifically, the hook assembly 31 includes an L-shaped body 311 having a through hole 311A, and an inverted U-shaped hook 312.

As shown in FIG. 8B specifically, in another configuration the hook assembly 31 includes an L-shaped body 311 having a through hole 311A, and a bifurcated hook 312 having a recess in each of two parts.

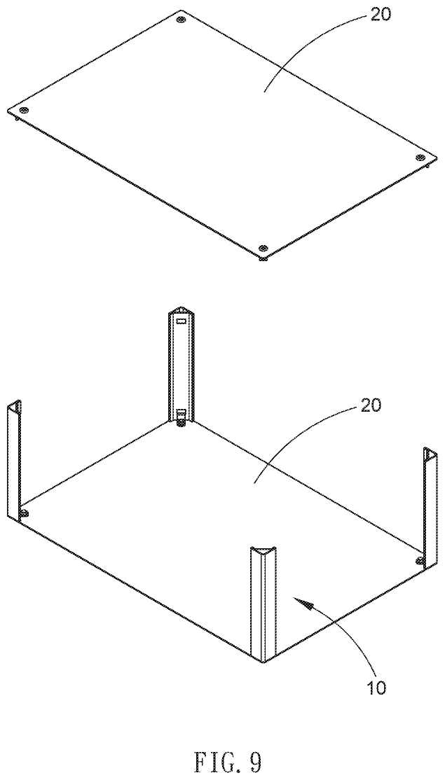

Referring to FIG. 9, a cabinet of a second preferred embodiment of the invention is shown. The characteristics of the second preferred embodiment are substantially the same as that of the first preferred embodiment except the following: three board elements 40 are eliminated. The upper and lower ones of the board members 20 are fastened together by the upright members 10.

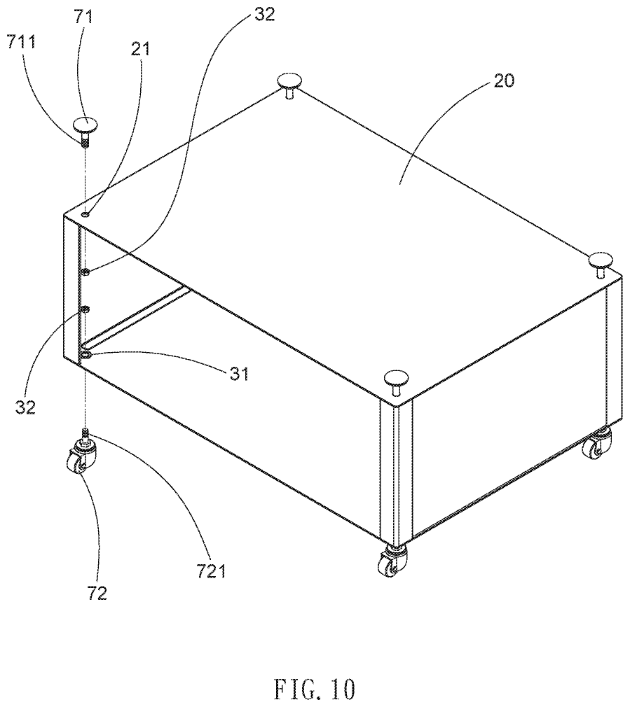

Referring to FIG. 10, a cabinet of a third preferred embodiment of the invention is shown. The characteristics of the third preferred embodiment are substantially the same as that of the second preferred embodiment except the following: four height adjustment members 71 are provided. The height adjustment member 71 includes a threaded shank 711 driven through the through hole 21, the hook assembly 31 and the bolt and nut combination 32 (i.e., the nut) to adjustably secure the height adjustment member 71 to the upper one of the board members 20. Four casters 72 are provided. The caster 72 includes a threaded shank 721 driving through the through hole 21, the hook assembly 31 and the bolt and nut combination 32 (i.e., the nut) to mount the caster 72 to one of four bottom corners of the cabinet. Assembly of the height adjustment member 71 and that of the caster 72 are the same with the hook assembly 31 disposed on top and bottom respectively.

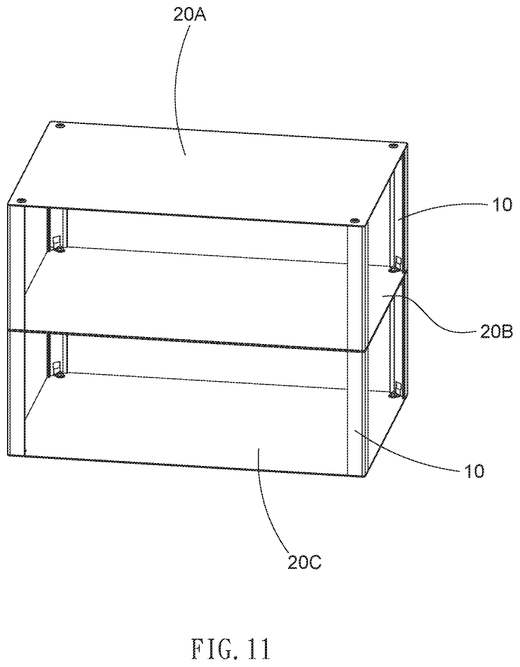

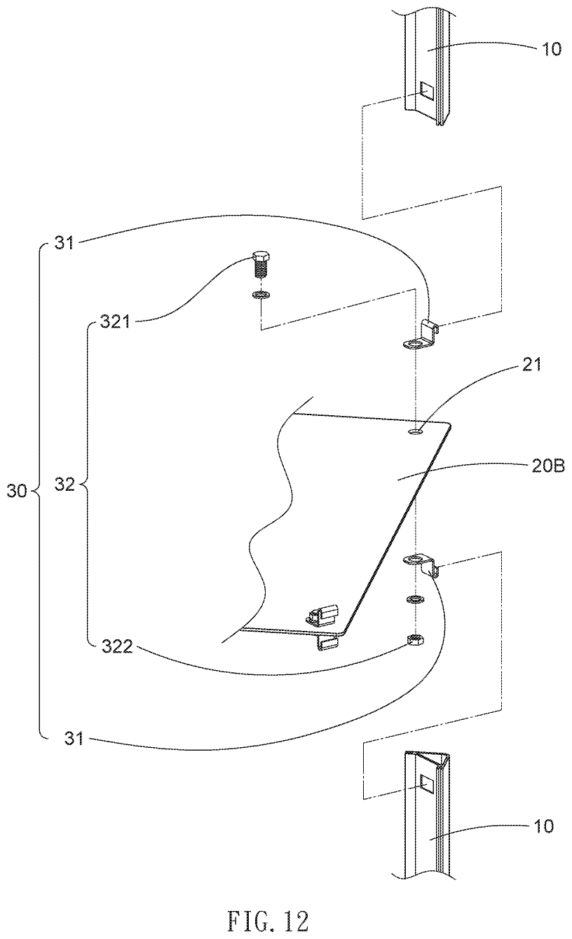

Referring to FIGS. 11 and 12, a cabinet of a fourth preferred embodiment of the invention is shown. The characteristics of the fourth preferred embodiment are substantially the same as that of the first preferred embodiment except the following: eight upright members 10 and first, second and third board members 20A, 20B and 20C are provided, i.e., being a double-deck cabinet with the third board member 20C as a base board of the cabinet. In assembly, a hook of a first hook assembly 31 is inserted through a second through hole 122 of an upper upright member 10 with a lower edge of the second through hole 122 in a hook of the first hook assembly 31, a hook of a second hook assembly 31 is inserted through a first through hole 121 of a lower upright member 10 with an upper edge of the first through hole 121 in a hook of the second hook assembly 31, and a bolt 321 of a bolt and nut combination 32 is driven through a through hole of the first hook assembly 31, a through hole 21, a through hole of a second hook assembly 31 and a nut 322 of the bolt and nut combination 32 to secure the lower upright member 10, the board member 20B and the upper upright member 10 together. Similar parts are assembled as above to finish a complete double-deck cabinet.

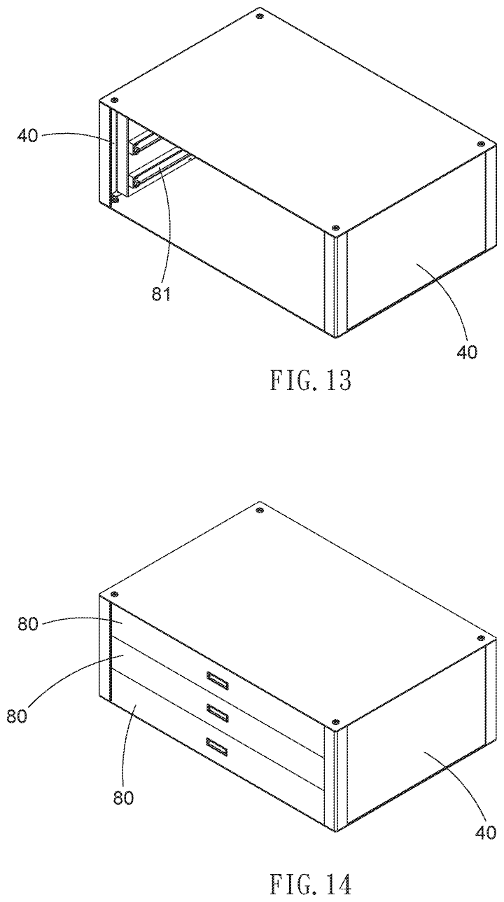

Referring to FIGS. 13 and 14, a cabinet of a fifth preferred embodiment of the invention is shown. The characteristics of the fifth preferred embodiment are substantially the same as that of the first preferred embodiment except the following: Two slides 81 are provided on an inner surface of either side (e.g., board element 40). Three drawers 80 are slidably mounted on the slides 81 of the same elevation.

While the invention has been described in terms of preferred embodiments, those skilled in the art will recognize that the invention can be practiced with modifications within the spirit and scope of the appended claims.

What is claimed is:

1. A cabinet comprising:
a plurality of upright members each having a triangular section and including two outer boards perpendicular to each other, an inner board, and two longitudinal groove formed at a joining portion of a first end of the inner board and an end of one outer board and at a joining portion of a second end of the inner board and an end of the other outer board respectively wherein the inner board includes a first through hole adjacent to an upper end, and a second through hole adjacent to a lower end;
a plurality of board members each including four third through holes at four corners respectively;
a plurality of fastening devices disposed at the third through holes of the board members respectively, each fastening device including a hook assembly and a bolt and nut combination for securing the hook assembly, the upright member, and the board member together; and
a plurality of board elements each having two ends complimentarily disposed in the grooves of two adjacent ones of the upright members respectively;
wherein each board member is sealingly disposed on tops or bottoms of the upright members;
wherein the first one of the hook assemblies associated with the upper one of the board members passes through the first through hole and is attached thereto, and
wherein the second one of the hook assemblies associated with the lower one of the board members passes through the second through hole and is attached thereto.

2. The cabinet of claim 1, wherein the hook assembly includes a body having a fourth through hole, and the bolt and nut combination includes a nut and a bolt; wherein (i) the hook is inserted through the first through hole with an upper edge of the first through hole in the hook, and the bolt is driven through the fourth through hole of the body, the third through hole and, the nut to secure the upright member and the upper one of the board members together; or (ii) the hook is inserted through the second through hole with a lower edge of the second through hole in the hook, and the bolt is driven through the fourth through hole of the body, the third through hole and, the nut to secure the upright member and the lower one of the board members together.

3. The cabinet of claim 2, wherein the body is shaped as an L and has the fourth through hole, and the hook is shaped as an inverted U.

4. The cabinet of claim 2, wherein the body is shaped as an L and has the fourth through hole, and the hook is shaped as a bifurcation having a recess in each of two parts.

5. The cabinet of claim 1, further comprising a plurality of height adjustment members disposed on a top of the upper one of the board members.

6. The cabinet of claim 5, wherein the height adjustment member includes a threaded shank driven through the third through hole, the hook assembly, and the bolt and nut combination to adjustably secure the height adjustment member to the upper one of the board members.

7. The cabinet of claim 1, wherein further comprising a plurality of casters disposed on a bottom of the lower one of the board members.

8. The cabinet of claim 7, wherein the caster includes a threaded shank driving through the third through hole, the hook assembly, and the bolt and nut combination to adjustably secure the caster to the upper one of the board members.

9. The cabinet of claim 1, further comprising at least one set of flush slides, each set of flush slides disposed on inner surfaces of the opposite ones of the board elements, and at least one drawer each slidably disposed on the set of flush slides.

10. The cabinet of claim 1, wherein the board element is at an angle of 135 degrees with respect to the inner board.
